(19) United States
(12) Patent Application Publication
(10) Pub. No.: US 2018/0236399 A1
(43) Pub. Date: Aug. 23, 2018

(54) GAS FILTRATION SYSTEM AND METHOD

(71) Applicant: KONINKLIJKE PHILIPS N.V., EINDHOVEN (NL)

(72) Inventor: JOHAN MARRA, EINDHOVEN (NL)

(21) Appl. No.: 15/754,338

(22) PCT Filed: Sep. 16, 2016
(86) PCT No.: PCT/EP2016/071955

§ 371 Date: Feb. 22, 2018

(30) Foreign Application Priority Data
Sep. 17, 2015 (EP) EP15185612.7

(51) Int. Cl. B01D 53/30; B01D 53/04; B01D 53/14; B01D 53/72

(52) U.S. Cl. CPC B01D 53/30; B01D 53/0407; B01D 53/1412; B01D 2259/4508; B01D 53/0454; B01D 53/1456; B01D 53/72

(57) ABSTRACT

Presented is a filtration system (10) for removing a target gaseous pollutant from a gas to be filtered in an indoor space, the filtration system (10) comprising: a sensor arrangement (12), which comprises a gas sensor (14) for sensing a concentration of a target gas in the indoor space; an air cleaner (20) which comprises a filter (22) for filtering the target gas from the gas to be filtered, and a ventilation system (24) for controllably driving air through the filter (22), wherein the filter (22) comprises a reversible absorption filter or a reversible adsorption filter; and a controller (26) for controlling ventilation system air flow settings, wherein the controller (26) is adapted, based on current sensor arrangement signals, and a previous history of the sensor arrangement signals, and previous ventilation system air flow settings, to: determine a degree of filter (22) loading with the target gas; determine from the degree of filter (22) loading with the target gas a concentration of the target gas in the air flow exiting the air cleaner (20); and determine when filter (22) regeneration is taking place and when air filtering is taking place from the determined concentration of the target gas in the air flow exiting the air cleaner (20). Further, a method of controlling a filtration system for removing a target gaseous pollutant from a gas to be filtered in an indoor space is presented.

### FIELD OF THE INVENTION

The invention relates to methods and apparatus for filtering gaseous pollutants from a gas to be filtered.

### BACKGROUND OF THE INVENTION

Indoor air pollution presents a significant health hazard in many urbanized areas across the world. Air pollution sources are encountered both outdoors (e.g. from motor vehicles and industry) and indoors (from cooking, smoking, candle burning, incense burning, outgassing building/decoration materials, use of outgassing waxes, paints, polishes etc.). The pollution level indoors is often higher than outdoors. At the same time, many people reside most of their time indoors and may thus be almost continuously exposed to unhealthy levels of air pollution.

One method to improve the indoor air cleanliness is by installing an air cleaner indoors which is capable of continuously recirculating the indoor air through a cleaning unit comprising one or more air filters. Another method to improve the indoor air cleanliness is by applying continuous ventilation with filtered outdoor air. In the latter case, the air filter(s) are usually comprised in a heating, ventilation and air conditioning (HVAC) system capable of temperature adjustment, ventilation, and of cleaning the ventilation air drawn from outdoors by passing it first through one or more air filters before releasing it indoors. Ventilation with cleaned outdoor air displaces polluted indoor air and dilutes the pollution level therein.

For removing polluting gases from air, use of often made of activated carbon filters which are capable of adsorbing/removing many volatile organic hydrocarbon gases (VOCs) and several inorganic gases (NO₂, O₃, radon) from air. The activated carbon material is usually present as granules that are contained in an air-permeable filter frame structure.

Indoor air pollution with formaldehyde gas is a particular problem affecting the health and well-being of many people. Formaldehyde is continuously emitted from indoor sources such as building materials, decoration material, and furniture. Its indoor concentration can increase to well above the clean air guideline concentrations for formaldehyde (0.05 mg/m³ at 8 hour exposure, 0.10 mg/m³ at 1 hour exposure) when the room is poorly ventilated. High ventilation conditions achieved by opening windows and doors are not always feasible due to outdoor weather conditions, an uncomfortable outdoor temperature, and/or safety considerations.

For removing formaldehyde and/or small acidic gases (SO₂, acetic acid, formic acid, HNOₓ) from air, activated carbon as such is also not very effective. Instead, use can be made of impregnated filter materials capable of chemically absorbing these gases from air. Absorption can occur via acid-base interactions or through a chemical condensation reaction. Activated carbon granules can be used as the impregnation carrier, but also hydrophilic fibrous cellulose paper, glass-fiber sheet material, and porous ceramic honeycomb structures are suitable for this purpose.

US 2015/0202565 A1 discloses an air purification system for indoor and in-vehicle air cleaning. The system consists of particle filter, toxic chemical and odor absorber, particle and chemical pollutant gas sensors, and a smart control unit with internet-enabled data terminal connected with user's smart devices via Wi-Fi or cellular 3G and 4G LTE.

In EP 1 402 935 A1 a method and an arrangement are disclosed for monitoring the operational status of an apparatus for adsorbing pollutants from a source of polluted gas and desorbing said pollutants to an internal combustion engine.

U.S. Pat. No. 6,071,479 and WO 2013/008170 disclose gas filter structures comprising chemically-impregnated paper or glass-fiber material for removing formaldehyde.

When using such filters structures, an indoor air cleaner re-circulates the air in a given enclosure through a filter stack comprising the formaldehyde absorption filter.

A problem with known formaldehyde absorption filters is their limited lifetime. The functionality of the formaldehyde absorption filter relies on the presence of a chemical impregnant, such as tris-hydroxymethyl-aminomethane, in the filter that is capable of absorbing formaldehyde gas via a chemical condensation reaction.

It has been discovered that this condensation reaction is reversible. When clean air is passed through an absorption filter that is partially loaded with absorbed formaldehyde gas, desorption of formaldehyde gas may occur which makes the absorption filter become a source of formaldehyde gas itself.

Furthermore, the 1-pass formaldehyde absorption efficiency of the filter is also found to depend on the relative humidity (RH) and on the state of filter loading with absorbed formaldehyde. Because the overall absorbed amount of formaldehyde in the filter depends on the details of the filter structure, the filter impregnation, and the filter's exposure history to air of varying relative humidity and formaldehyde levels, and wherein also the airflow through the filter is often allowed to vary in the course of time, it is difficult to predict the effectiveness of the absorption filter at any moment in time with respect to its ability to clean the air from formaldehyde gas.

### SUMMARY OF THE INVENTION

Desirable would be a filter and filtering method suitable for removing gaseous pollutants from air, in particular formaldehyde, which prolongs the filter lifetime while also enabling sufficient filtering efficiency to be ensured over time in an energy-efficient manner and the signaling of moment at which the filter should be replaced for a fresh filter (i.e, the end of the filter life).

The invention is defined by the independent claims. The dependent claims define advantageous embodiments.

According to an aspect of the invention, there is provided a filtration system for removing a target gaseous pollutant from a gas to be filtered in an indoor space, the filtration system comprising:

a sensor arrangement, which comprises a gas sensor for sensing a concentration of a target gas in the indoor space;

an air cleaner which comprises a filter for filtering the target gas from the gas to be filtered, and a ventilation system for controllably driving air through the filter; and

a controller for controlling the ventilation system air flow setting,

wherein the controller is adapted, based on current sensor arrangement signals, and a previous history of the sensor arrangement signals, and previous ventilation system air flow settings, to:
determine a degree of filter loading with the target gas; and
optionally determine when the filter has reached its end of life.

This system evaluates the use and performance of a gas filter, by monitoring over time the target gas concentration in the indoor space and the ventilation settings (e.g. fan speed). In this way, the loading of the filter with target gas resulting from the filtering is determined. This enables the filter end of life to be determined accurately.

Preferably, the sensor arrangement further comprises a temperature sensor, and a relative humidity sensor. This allows for a more accurate control of the filtration system.

The filter comprises a reversible absorption filter or a reversible adsorption filter.

The controller is further adapted to:

determine from the degree of filter loading with the target gas a concentration of the target gas in the air flow exiting the air cleaner, for example if the ventilation system is turned on; and

determine when filter regeneration is taking place and when air filtering is taking place. Via a user interface, the user may be notified of whether filter regeneration is taking place or whether air filtering is taking place. This allows the user to take appropriate action, e.g. ventilating the room. The user interface may be a display which is part of the filtration system. Alternatively, the filtration system may comprise wireless components configured to notify a user wirelessly, for example via a device of the user, for example a smartphone.

This approach enables the target gas concentration at the filter exit to be determined. The controller may aim to maintain both the target gas concentration in the indoor space and the target gas concentration at the filter exit to be within desired levels. This enables the filter regeneration to be controlled for example by keeping the ventilation system running even when the target gas concentration in the indoor space is below a desired minimum level. The historical (partial) filter regenerations are also evident from the previous history so that the end of filter life determination takes account of previous filter use as well as previous filter regenerations.

In the case of an absorption filter, the periodic regeneration of the reversible filter takes place through target gas desorption and this can be allowed to take place under conditions of high indoor space ventilation with outdoor air, as characterized by a low indoor target gas concentration. Under conditions of low indoor space ventilation with outdoor air, the gas filter instead cleans the indoor air, namely when the gas sensor system senses an elevated indoor gas concentration.

The system may operate in an automatic mode with a minimized expense of energy, to continuously aim to obtain a sufficiently low indoor target gas concentration while retaining as much as possible a sufficient functionality of the gas filter. This enables an extended functional life of the gas filter, thereby reducing or even avoiding the need for filter replacement.

The controller may further be adapted to switch off the ventilation system when it is determined that:

the filter has reached its end of life; or

the gas sensor reading is below a first threshold and the determined concentration of the target gas in the air flow exiting the air cleaner is below a second threshold.

When the gas filter has reached the end of its life, its filtering performance towards the target gas has become too low to be acceptable and the air cleaner comprising the gas filter should not be used any longer. When the gas sensor reading and the determined target gas concentration exiting the gas filter are both low, air filtering is not needed and filter regeneration is not needed, so that energy can be saved by turning off the ventilation system comprised in the air cleaner.

The controller may be further adapted to:

determine that filter regeneration is taking place when the determined concentration of the target gas in the air flow exiting the air cleaner is greater than the gas sensor reading.

If the ventilation system comprised in the air cleaner is operated during this time, filter regeneration takes place. This will only be carried out if the determined concentration of the target gas in the air flow exiting the air cleaner remains nevertheless below a maximum safety threshold.

The controller may be further adapted to:

determine that air filtering is taking place when the determined concentration of the target gas in the air flow exiting the air cleaner is lower than the gas sensor reading.

This indicates that the filter is providing the desired drop in the target gas concentration in the indoor space, thus cleaning the air therein.

The controller may be further adapted to:

determine that the filter has reached its end of life when the determined concentration of the target gas in the air flow exiting the air cleaner is above a third threshold.

This third threshold may be a maximum permitted level, which indicates that the degree of filter loading with target gas has exceeded a maximum level above which the filter has become unable to effectively remove the target gas from the air in the indoor space. The gas filter should then no longer be used.

The controller may be further adapted to:

provide an output which indicates when additional ventilation of the indoor space with outdoor air is desirable.

Additional ventilation with outdoor air, wherein a low (or zero) target gas concentration is present, may be desired at times of high concentration of the target gas in the indoor space, or to make the filter regeneration more effective.

The gas sensor may comprise a formaldehyde sensor, and the reversible gas filter then comprises a reversible absorption formaldehyde filter. The invention may however also be applied to reversible adsorption filters, such as activated carbon or zeolite adsorption filters, and these may be used for the filtering of volatile organic compounds (VOCs).

According to an embodiment of the invention, the gas sensor comprises a formaldehyde sensor, wherein the target gas is formaldehyde, wherein the filter comprises a reversible formaldehyde filter, and wherein the degree of filter loading Γ(t) with formaldehyde is determined at successive moments in time t=tᵢ (i=0, 1, 2, . . . , i−1) via the formula:

Γ(tᵢ)=Γ(tᵢ₋₁)+ϕ_{c}(tᵢ)×Δt×(c_{gas}(tᵢ)−Z(ϕ_{c}(tᵢ),RH(tᵢ),T(tᵢ),Γ(tᵢ₋₁),c_{gas}(tᵢ))

wherein the time interval Δt=tᵢ tᵢ₋₁; wherein Γ represents the absorbed amount of formaldehyde gas; wherein ϕ_{c} represents the airflow rate at the pertaining ventilation system air flow setting; wherein RH represents the relative humidity in the indoor space; wherein T represents the temperature in the indoor space; wherein c_{gas} represents the concentration of a target gas in the indoor space; and wherein Z(ϕ_{c}(tᵢ),RH(tᵢ),T(tᵢ),Γ(tᵢ₋₁),c_{gas}(tᵢ) represents the formaldehyde concentration in the air exiting the filter.

Examples in accordance with another aspect of the invention provide a method of controlling a filtration system for removing a target gaseous pollutant from a gas to be filtered in an indoor space, comprising:

sensing a concentration of a target gas in the indoor space; and

controlling the air flow setting of a ventilation system of an air cleaner, the air cleaner comprising a filter for filtering the target gas from the gas to be filtered, and the ventilation system for controllably driving air through the absorption filter,

wherein the control of the ventilation system comprises, based on current sensed values, and a previous history of the sensed values, and previous ventilation system air flow settings:
determining a degree of filter loading with the target gas; and
optionally determining when the filter has reached its end of life based on the degree of filter loading with the target gas.

This method provides accurate determination of the end of life of the filter.

The filter comprises a reversible absorption filter or a reversible adsorption filter, and the method further comprises:

from the degree of filter loading, determining a concentration of the target gas in the air flow exiting the air cleaner, for example if the ventilation system is turned on; and

determining when filter regeneration is taking place and when air filtering is taking place. The method may comprise a step of notifying the user of whether filter regeneration is taking place or whether air filtering is taking place, for example via a user interface. This allows the user to take appropriate action, e.g. ventilating the room or not. The notification may be displaying a message on a display of the filtration system or wirelessly transmitting a message to a device of the user, e.g. a smartphone.

In this way, the method also enables the lifetime to be maximized by controlling filter usage and regeneration over time.

The method may further comprise steps to make the determinations as outlined above, as well as temperature and/or relative humidity sensing steps.

The method may be implemented by a computer program comprising code means for implementing an algorithm.

### BRIEF DESCRIPTION OF THE DRAWINGS

Examples of the invention will now be described in detail with reference to the accompanying drawings, in which:

FIG. 1 shows a gas filtration system; and

FIG. 2 shows a gas filtration method.

### DETAILED DESCRIPTION OF THE EMBODIMENTS

The invention provides a gas filtration system which has a gas sensor for sensing a concentration of a target gas, a temperature sensor and a relative humidity sensor. An air cleaner is controlled by a controller which makes use of the current sensor signals as well as the previous history of the sensor signals and the previous air cleaner flow settings. In this way, it becomes possible to determine a degree of filter loading with the target gas, and thereby determine when the filter has reached its end of life. If a reversible filter is used, the concentration of the target gas in the air flow exiting the air cleaner can be determined (if the ventilation system (e.g. the fan) comprised in the air cleaner is turned on). It can thus be determined when filter regeneration is taking place and when air filtering is taking place, and the end of life determination takes into account previous regeneration cycles.

This system evaluates the use of a gas filter, by monitoring over time the target gas concentration, the relative humidity, the temperature, and the air cleaner settings. The controller may aim to maintain both the target gas concentration in the indoor space and the gas concentration at the filter exit to be within desired levels. It provides an accurate determination of the end of life of the filter and in some examples also providing controlled filter regenerations when needed and when the indoor air quality conditions are suitable for that purpose.

The invention is of particular interest for removing formaldehyde gas from an indoor space, and an example will now be given of a reversible gas filtration system specifically for formaldehyde gas.

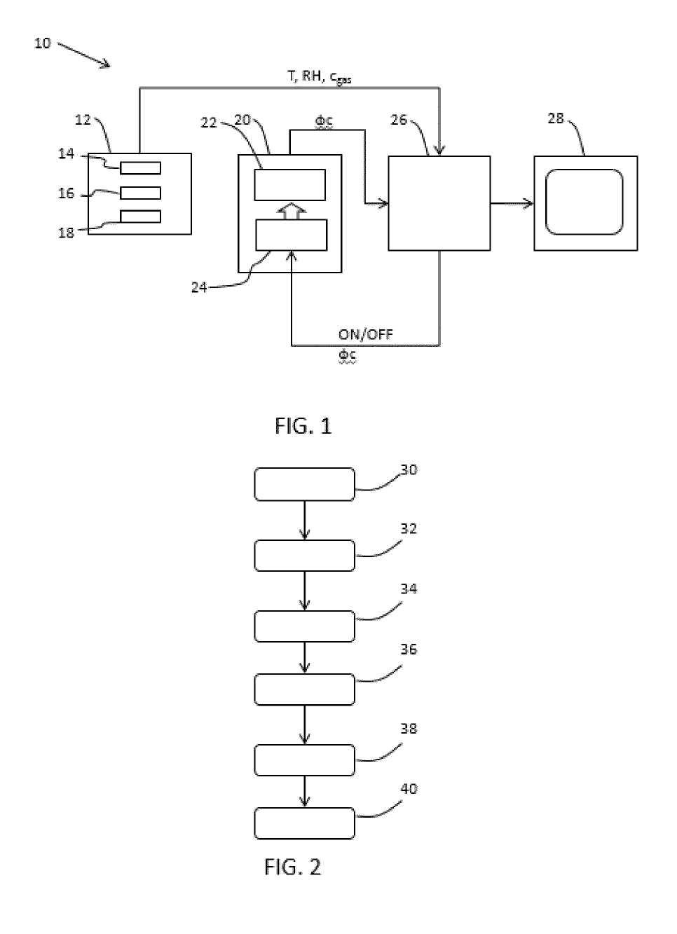

FIG. 1 shows the gas filtration system 10. It comprises a sensor arrangement 12, which comprises a gas sensor 14 for sensing a concentration of formaldehyde gas in the indoor space (c_{gas}), a temperature sensor 16 for providing a temperature reading (T) and a relative humidity sensor 18 for providing a relative humidity reading (RH). In a cost-down version, pre-set average values are used for temperature and relative humidity instead of sensed values.

An air cleaner 20 comprises a reversible absorption filter 22 for filtering the formaldehyde from the air and a ventilation system 24, such as a fan, for controllably driving air through the filter 22.

A controller 26 controls the ventilation system air flow setting ϕ_{c}. At the simplest level, there is only on/off control. However, more preferably, there is control of the air flow rate through the filter.

The controller 26 receives the current sensor signals (RH, T, c_{gas}) and the previous history of the sensor arrangement signals and the previous ventilation system air flow settings (ϕ_{c}). It stores this historical data, and uses it to determine various parameters discussed below. The controller implements an algorithm to provide the data analysis.

The controller controls an output device 28 which is used to deliver information about the filtration system and the air quality in the room. The output device issues recommendations about the desired room ventilation level with outdoor air. The output device may be a part of the system, or it may be a remote device such as a smartphone or tablet of the user of the system, to which signals are sent (wirelessly) by the controller.

The filtration system enables, whenever needed, the periodic (partial) regeneration of the formaldehyde absorption filter through desorption of formaldehyde under conditions of high ventilation with outdoor air and thus a low indoor formaldehyde concentration level. The desorbed formaldehyde gas is thereby displaced from the indoor space to outdoors by the ventilation air. The formaldehyde concentration in outdoor air is usually very low if not zero. Applying a high ventilation level with outdoor air is feasible when the outdoor air temperature is at a comfortable level, and when acceptable outdoor weather conditions exist. Under low ventilation conditions, the filtration system is enabled to clean the indoor air from the formaldehyde emitted from indoor sources in case the formaldehyde gas sensor system senses an elevated indoor concentration.

Using the algorithm operated by the controller, the filtration system is configured such that, in an automatic mode, it operates such as to aim for a sufficiently low indoor formaldehyde concentration at all times, while at the same time retaining a sufficient functionality of the absorption filter. A further aim is that these actions are carried out at the expense of a minimized amount of energy. This enables the automatic and sustainable realization of a long or even indefinite functional life of the gas absorption filter.

The system is for example to be placed in a room to clean the air therein from formaldehyde whenever the need arises.

The system can be based on known sensors and filter designs, for example as disclosed in WO 2013/008170 and U.S. Pat. No. 6,071,479. The formaldehyde sensor is capable of selectively measuring the ambient formaldehyde gas concentration c_{gas} over the course of time.

The air cleaner 20 comprises a formaldehyde absorption filter 22 wherein formaldehyde is reversibly absorbed from air. Reversible absorption means that the filter removes formaldehyde from the air in the room via absorption when a relatively high formaldehyde concentration is present in the air under the condition that only a relatively small amount of absorbed formaldehyde gas is already absorbed in the filter. This can happen when the ventilation level in the room is low. In reverse, the filter releases formaldehyde gas back to the air when a relatively low formaldehyde concentration is present in the air while a relatively large amount of absorbed formaldehyde is already present in the filter. This can happen when the room is well ventilated, for example when at least one of its windows is open.

The desorbed formaldehyde is thereby readily displaced from indoors to outdoors together with the ventilation air so that it does not lead to a marked increase in the indoor formaldehyde concentration.

The absorption reversibility is akin to a chemical equilibrium between two species, in this case the non-absorbed formaldehyde concentration (c_{gas}) in air and the amount of formaldehyde (Γ(c_{gas})) that can be absorbed in the filter at the concentration c_{gas} in air. The gas concentration c_{gas} is expressed in the unit “g/m³”, the absorbed amount Γ(c_{gas}) is expressed in the unit “g” (gram). Here, the chemical equilibrium constant C_{f} determines the equilibrium partitioning of the species between the absorbed state (Γ(c_{gas})) and the non-absorbed state (c_{gas}) according to:

C_{f}=Γ(c_{gas})/c_{gas}

The unit of C_{f} is therefore “m³”. The chemical equilibrium constant C_{f} is the analogue of the capacitance of an electrical capacitor where C_{f} represents the ratio of the charge Q on the capacitor plates and the voltage drop V between the capacitor plates. As such, C_{f} may also be considered to represent the filter capacitance for formaldehyde. At equilibrium, a higher c_{gas} allows a higher value of Γ(c_{gas}) to be reached. When an airflow, wherein initially a formaldehyde concentration c_{gas} is present, passes through a reversible absorption filter wherein an absorbed amount Γ of formaldehyde is present, the filter reduces c_{gas} in the airflow through absorption when Γ<Γ(c_{gas}) and increases c_{gas} in the airflow through desorption when Γ>Γ(c_{gas}).

An example of a reversible formaldehyde absorption filter is disclosed in U.S. Pat. No. 6,071,479. It features a corrugated paper structure wherein the porous paper material is impregnated with a mixture of a base (KHCO₃), a humectant (Kformate), and an organic amine (Tris-hydroxymethyl-aminomethane (Tris)). Preferably, the filter impregnation is carried out with an aqueous impregnant solution comprising:

KHCO₃ at a concentration preferably chosen in the 5-15% w/w range;

Kformate at a concentration preferably chosen in the 5-20% w/w range;

Tris at a concentration preferably chosen in the 5-25% w/w range.

For that purpose, a fixed volume Vᵢₘₚ of the impregnant solution is incorporated in the filter's paper structure per unit filter volume, followed by drying.

It has been discovered that the absorption filter capacitance C_{f} is proportional to Vᵢₘₚ, the relative humidity, and the filter volume. When the amount of the impregnants in the filter become a limiting factor with regard to the absorbed amount Γ(c_{gas}), C_{f} becomes also dependent on Γ. Instead of a corrugated structure, the filter can alternatively have a parallel-plate structure, a honeycomb structure, or a granular structure.

For the purposes of analysis, a formaldehyde absorption filter may be considered of thickness L and filter face area A_{filter} that is impregnated with a volume Vᵢₘₚ of impregnant solution of a certain fixed composition per unit filter volume.

When this filter is loaded with an amount Γ of absorbed formaldehyde gas, it has been found that when the filter is targeted with an airflow ϕ_{c} wherein a formaldehyde concentration c_{gas} is present, it emits a formaldehyde concentration cₑₓᵢₜ in the air exiting the filter that can be predicted with a mathematical function Z(ϕ_{c},RH,T,Γ,c_{gas}) according to:

cₑₓᵢₜ=Z(ϕ_{c},RH,T,Γ,c_{gas})

The function Z(ϕ_{c},RH,T,Γ,c_{gas}) also depends on:
the filter face area A_{filter},
the filter thickness L,
Vᵢₘₚ,
the composition of the impregnant solution,
the details of the chosen filter structure.

However, these remain constant after the filter has been manufactured and installed in the air cleaner and will therefore not be explicitly mentioned. They translate to a constant value or scaling factor.

The explicit form of the function Z(ϕ_{c},RH,T,Γ,c_{gas}) can be obtained through a combination of mathematical modelling and filter testing as a function of all above-mentioned variables and filter design/impregnation parameters. For example, using this approach, it has been discovered that

$$Z ( {φ}_{c} , RH , T , {c}_{gas} ) = {c}_{gas} - ( 1 - exp ( - n ) ) \times ( {c}_{gas} - \frac{Γ}{{C}_{f}} )$$

wherein “n” is a process parameter depending, amongst others, on RH, T and ϕ_{c}. When Γ=0 (a fresh absorption filter), one determines from the above equation for Z(ϕ_{c},RH,T,Γ,c_{gas}) that

$$\begin{matrix}Z ( {φ}_{c} , RH , T , {c}_{gas} ) = {c}_{exit} \\ = {c}_{gas} - ( 1 - exp ( - n ) ) \times {c}_{gas} \\ = {c}_{gas} exp ( - n )\end{matrix}$$

For a given absorption filter and a set of defined conditions with respect to RH, T, and ϕ_{c}, the process parameter “n” can therefore be determined from the measurement of cₑₓᵢₜ downstream from a fresh filter according to:

$$\frac{{c}_{exit}}{{c}_{gas}} = exp ( - n )$$

In the limit wherein C_{f}→∞, the reversible absorption filter turns into an irreversible absorption filter from which no desorption is possible.

Filter regeneration is then no longer possible, and the process parameter “n” becomes a function of F. This was found to be the case when acidic gases (e.g., SO₂, HNOₓ, carboxylic acids) absorb in alkaline-impregnated filters or when alkaline gases (e.g., NH₃, organic amines) absorb in acid-impregnated filters. The above-mentioned reversible formaldehyde absorption filter acts as an irreversible alkaline-impregnated filter towards acidic gases.

When an irreversible absorption filter becomes saturated with absorbed gas, the process parameter n→0. In that situation, one has cₑₓᵢₜ=cᵢₙ and the filter has reached its end of life and is no longer functional.

Concerning the reversible formaldehyde filter, the parameters RH, T and c_{gas} are obtained at any time as input data from the formaldehyde sensor and the RH,T sensor system. The flow rate ϕ_{c} through the filter is obtained at any time from the recorded airflow settings of the air cleaner 20.

To obtain the absorbed amount Γ(tₙ) at any time “t=tₙ”, the entire exposure history of the filter to formaldehyde gas becomes involved and this can be achieved by taking into account RH(tᵢ), T(tᵢ), c_{gas}(tᵢ), ϕ_{c}(tᵢ) and cₑₓᵢₜ(tᵢ) for all values i≤n. Γ(tₙ) can then be obtained as follows:

At t=tᵢ:

Γ(tᵢ)=Γ(tᵢ₋₁)+ϕ_{c}(tᵢ)×Δt×(c_{gas}(tᵢ)−Z(ϕ_{c}(tᵢ),RH(tᵢ),T(tᵢ),Γ(tᵢ₋₁),c_{gas}(tᵢ))

wherein

Δt=tᵢ−tᵢ₋₁

This is the time interval between two successive measurements of the various parameters.

At t=0, the filter is still fresh and therefore Γ=0. Γ(t) is therefore obtained according to a tracking procedure that extends across the entire operational history of the filter. The tracking procedure is carried out by the controller.

With the availability of all input data RH(tᵢ), T(tᵢ), c_{gas}(tᵢ), ϕ_{c}(tᵢ), cₑₓᵢₜ(tᵢ) and Γ(t) at t=tᵢ, i=0, 1, 2, . . . n, the algorithm enables the delivery of various messages to the user.

These messages include:

the current relative humidity and temperature readings;

an air quality reading indication (for example with three levels 1 (good) to 3 (poor));

an indication of the degree of filter loading with gas;

an indication that filter regeneration is currently taking place;

an indication that filter replacement is needed;

an indication that additional ventilation with outdoor air is advised.

The controller provides electronic feedback to the air cleaner to control/change its ON/OFF status and to set its airflow rate ϕ_{c} in order to optimally meet the requirements of clean indoor air and the availability of a sufficiently functional gas absorption filter at all times at the expense of only a minimized energy consumption.

The algorithm comprises a decision protocol that involves the use of several pre-defined formaldehyde concentrations. These are defined as:

c_{in,min}: the clean indoor air guideline formaldehyde concentration standard (8 hour exposure) set at c_{in,min}=0.05 mg/m³. At c_{gas}≤c_{in,min}, no air cleaning is needed.

c_{in,max}: a high indoor formaldehyde concentration, which can, for example, be set at about 5 times the value of c_{in,min}. At c_{gas}≥c_{in,max}, extra ventilation with outdoor air is recommended.

c_{exit,min}: a lower formaldehyde concentration level emitted from the filter, which can, for example, be set at c_{exit,min}=0.025 mg/m³. At cₑₓᵢₜ≤c_{exit,min}, no filter regeneration is needed.

c_{exit,max}: an upper formaldehyde concentration level emitted from the filter, which can, for example, be set at c_{exit,max}=0.15 mg/m³. At cₑₓᵢₜ≥c_{exit,max}, filter replacement is recommended.

Based on these values, various actions can be taken at any time and various messages and status updates can be provided to the user. It is implicitly assumed thereby that c_{exit,max}<c_{in,max} while c_{exit,min}<c_{in,min}.

The various different conditions are explained below.

if cₑₓᵢₜ≥c_{exit,max}

c_{gas}≥c_{in,max}

then messages: “air pollution level 3 (poor air quality)”
“filter replacement needed”
“extra ventilation recommended”
action: air cleaner OFF

This indicates that the gas filter is highly loaded with absorbed gas and should not be used. The filter should be replaced. However, there is also a high concentration in the indoor space with a poor air quality (level 3), so extra ventilation with outdoor air is desirable.

if cₑₓᵢₜ≥c_{exit,max}

c_{in,min}<c_{gas}<c_{in,max}

then messages: “air pollution level 2 (moderate air quality)”
“filter replacement needed”
“extra ventilation recommended”
action: air cleaner OFF

This indicates that the gas filter is fully highly loaded with absorbed gas and should not be used. The filter should be replaced. However, there is also a medium concentration in the indoor space with a medium air quality (level 2), so extra ventilation with outdoor air is desirable.

if cₑₓᵢₜ≥c_{exit,max}

c_{gas}≤c_{in,min}

then messages: “air pollution level 1 (good air quality)”
“filter replacement needed”
action: air cleaner OFF

This indicates that the gas filter is highly loaded with absorbed gas and should not be used. The filter should be replaced. There is also a low concentration in the indoor space with a good air quality (level 1) so additional ventilation with outdoor air is not needed.

if c_{exit,min}≤cₑₓᵢₜ<c_{exit,max}

c_{gas}≥c_{in,max}

then messages: “air pollution level 3 (poor air quality)”
“filter partially loaded”
“air cleaning in progress”
“extra ventilation recommended”
action: air cleaner ON

This indicates that the gas filter output is in an acceptable range. There is a high concentration in the indoor space with a poor air quality (level 3) so the air cleaner is used. The poor air quality means extra ventilation with outdoor air is also advised.

if c_{exit,min}<cₑₓᵢₜ<c_{exit,max}

c_{in,min}<c_{gas}<c_{in,max} and c_{gas}>cₑₓᵢₜ

then messages: “air pollution level 2 (moderate air quality)”
“filter partially loaded”
“air cleaning in progress”
action: air cleaner ON

This indicates that the gas filter output is in an acceptable concentration range, and indeed is lower than at the input. There is a medium concentration in the indoor space with a medium air quality (level 2) so the air cleaner is used.

if c_{exit,min}<cₑₓᵢₜ<c_{exit,max}

c_{in,min}<c_{gas}<c_{in,max} and c_{gas}≤cₑₓᵢₜ

then messages: “air pollution level 2 (moderate air quality)”
“filter partially loaded”
“filter regeneration in progress”
action: air cleaner ON

This indicates that the gas filter output is in an acceptable concentration range, but higher than (or equal to) that at the input. There is a medium concentration in the indoor space with a medium air quality (level 2). Filter regeneration can take place by keeping the air cleaner on, in order to reduce cₑₓᵢₜ.

if c_{exit,min}<cₑₓᵢₜ<c_{exit,max}

c_{gas}≤c_{in,min} and c_{gas}>cₑₓᵢₜ

then messages: “air pollution level 1 (good air quality)”
“filter partially loaded”
action: air cleaner OFF

This indicates that the gas filter output is in an acceptable concentration range, and indeed lower than at the input. There is a low concentration in the indoor space with a good air quality (level 1). Filter regeneration is not possible (because cₑₓᵢₜ<c_{gas}) and the air cleaner can be turned off, in order to save power.

if c_{exit,min}<cₑₓᵢₜ<c_{exit,max}

c_{gas}≤c_{in,min} and c_{gas}≤cₑₓᵢₜ

then messages: “air pollution level 1 (good air quality)”
“filter partially loaded”
“filter regeneration in progress”
action: air cleaner ON

This indicates that the gas filter output is in an acceptable concentration range, and higher than (or equal to) that at the input. There is a low concentration in the indoor space with a good air quality (level 1). Filter regeneration is possible (because cₑₓᵢₜ≥c_{gas}) and the air cleaner can be turned on for this purpose.

if cₑₓᵢₜ≤c_{exit,min}

c_{gas}≥c_{in,max}

then messages: “air pollution level 3 (poor air quality)”
“filter clean”
“air cleaning in progress”
“extra ventilation recommended”
action: air cleaner ON

This indicates that the gas filter output is low so the filter is clean. There is a high concentration in the indoor space with a poor air quality (level 3). The filter is used but also extra ventilation with outdoor air is advised.

if cₑₓᵢₜ≤c_{exit,min}

c_{in,min}<c_{gas}<c_{in,max}

then messages: “air pollution level 2 (moderate air quality)”
“filter clean”
“air cleaning in progress”
action: air cleaner ON

This indicates that the gas filter output is low so the filter is clean. There is a medium concentration in the indoor space with a medium air quality (level 2). The filter is used.

if cₑₓᵢₜ≤c_{exit,min}

c_{gas}≤c_{in,min}

then messages: “air pollution level 1 (good air quality)”
“filter clean”
action: air cleaner OFF

This indicates that the gas filter output is low so the filter is clean. There is a low concentration in the indoor space with a good air quality (level 1). The air cleaner is turned off to save power.

The above decision protocol is shown in the table below:

| | c_{gas} ≤ c_{in, min} | c_{in, min} < c_{gas} < c_{in, max} | c_{gas} ≥ c_{in, max} |
|---|---|---|---|
| cₑₓᵢₜ ≤ c_{exit, min} | 1 | 2 | 3 |
| | “pollution level #1” | “pollution level #2” | “pollution level #3” |
| | “filter clean” | “filter clean” | “filter clean” |
| | air cleaner OFF | “air cleaning” | “air cleaning” |
| | | air cleaner ON | “extra ventilation |
| | | | recommended” |
| | | | air cleaner ON |
| c_{exit, min} < cₑₓᵢₜ < | 4 | 5 | 6 |
| c_{exit, max} | @ c_{gas} ≤ cₑₓᵢₜ | @ c_{gas} ≤ cₑₓᵢₜ | @ c_{gas} > cₑₓᵢₜ |
| | “pollution level #1” | “pollution level #2” | (always) |
| | “filter partially | “filter partially | “pollution level #3” |
| | loaded” | loaded” | “filter partially |
| | “filter regeneration” | “filter regeneration” | loaded” |
| | air cleaner ON | air cleaner ON | “extra ventilation |
| | | | recommended” |
| | | | “air cleaning” |
| | 7 | 8 | air cleaner ON |
| | @ c_{gas} > cₑₓᵢₜ | @ c_{gas} > cₑₓᵢₜ | |
| | “pollution level #1” | “pollution level #2” | |
| | “filter partially | “filter partially | |
| | loaded” | loaded” | |
| | air cleaner OFF | “air cleaning” | |
| | | air cleaner ON | |
| cₑₓᵢₜ ≥ c_{exit, max} | 9 | 10 | 11 |
| | “pollution level #1” | “pollution level #2” | “pollution level #3” |
| | “filter replacement | “filter replacement | “filter replacement |
| | needed” | needed” | needed” |
| | air cleaner OFF | “extra ventilation | “extra ventilation |
| | | recommended” | recommended” |
| | | air cleaner OFF | air cleaner OFF |

The top of each cell has a cell number. In an automatic mode, the algorithm moves between cells in the manner explained below. The left column represents clean air in the space, the middle column represents medium air pollution and the right column represents poor quality air. The top row represents a clean air filter, the middle row represents a partially loaded filter, and the bottom row represents a filter that is highly loaded with absorbed gas.

The aim of the algorithm is to move to cell 1 if possible, which corresponds to low concentration in the indoor space and a regenerated filter.

Cell 3 proceeds to cell 2 which proceeds to cell 1. This takes place because the air cleaning reduces the pollution level over time.

Cell 6 proceeds to cell 8 when the initial air cleaning has taken effect.

From cell 8, if the gas concentration remains higher than the filter exit concentration, air cleaning continues until cell 7 is reached. The filter has not been regenerated because the gas concentration in the space is higher than at the filter exit.

From cell 8, if the gas concentration becomes lower than the filter exit concentration, air cleaner operation continues but this is implementing filter regeneration. Cell 4 is then reached. The air cleaner remains turned on to continue filter regeneration (air cleaning is not needed), so that the conditions eventually move to cell 1.

Cell 11 moves to cell 10 and to cell 9 if the user follows the advice of increasing the ventilation with outdoor air. In these cells, the air cleaner is turned off because the filter is recognized to emit an unacceptably high formaldehyde concentration with cₑₓᵢₜ≥c_{exit,max}. The filter itself becomes an unacceptable pollution source. It is then also ensured that the air cleaner remains switched off with the recommendation to replace the filter.

With the air cleaner switched off, only ventilation with outdoor air can help to clean the indoor air. It is to be noted that (extra) ventilation, whenever feasible, will always help to more quickly reduce c_{gas} and (at least partially) regenerate the filter. An occurrence of c_{gas}≥c_{in,max} is expected to be always due to insufficient ventilation and it is then advantageous to issue a recommendation (a warning message) about the desirability to increase the ventilation rate.

When cell 1 is reached, the air cleaner can be switched off in order to save energy.

To save on energy consumption and limit the noise produced by the air cleaner, it is advantageous to perform the periodic (partial) filter regenerations at a reduced flow rate ϕ_{c} whenever the conditions are such that the filter can be regenerated and when that is necessary.

The above decision protocol is made only on the basis of the indoor formaldehyde pollution level and the status of the formaldehyde absorption filter. It is recognized that the formaldehyde pollution level is only part of the overall indoor air pollution problem.

Information with regard to the indoor particle pollution level and/or the total volatile organic compound (TVOC) pollution level may be accounted for as well. In that case, the above protocol is to be incorporated in a broader decision protocol wherein compromises may be made in order to attain the best overall indoor air quality, thereby accounting for the presence of all airborne pollutants.

FIG. 2 shows a method of controlling a filtration system for removing a target gaseous pollutant from a gas to be filtered in an indoor space. The system makes use of a ventilation system of an air cleaner which comprises a reversible absorption filter for filtering the target gas from the air, and the ventilation system is for controllably driving air through the absorption filter.

The method comprises:

in step 30, sensing a concentration of a target gas in the indoor space, a temperature in the indoor space and the relative humidity in the indoor space.

in step 32, determining a degree of filter loading with the target gas, and thereby determining a concentration of the target gas in the air flow exiting the air cleaner if the ventilation system of the air cleaner is turned on;

in step 34, determining when filter regeneration is taking place and when air filtering is taking place; and

in step 36 determining when the filter has reached its end of life.

In dependence on the different determinations, information is provided to the user in step 38, in the form of messages, alerts, or advisory information. The ventilation system of the air cleaner is controlled in step 40.

These determinations are based on the current sensed values, and the previous history of the sensed values and the previous ventilation system air flow settings.

The above example is based on a reversible formaldehyde filter.

The invention may be applied to other reversible filters. For example, an activated carbon filter or a zeolite filter may be used for adsorbing volatile organic hydrocarbon gases (VOCs) from air. The same system may be used for such filters. The required gas sensor is then a VOC sensor capable a sensing (a range of) VOCs that can be adsorbed on and desorbed from the activated carbon or zeolite adsorbents.

Examples of VOC sensors are a photo-ionization detector (PID) and a metal-oxide semiconductor (MOS) sensor. Of course, the function Z will be different for different types of filter.

As outlined above, irreversible absorption filters may also be used. Filter regeneration through gas desorption is then no longer possible, but, with a suitable gas sensor, the approach described above can still be used to detect accurately the end of filter life. Status messages and smart ventilation control in the context of filter regeneration are then no longer relevant.

For example, the general tracking algorithm for a reversible filter, used for calculating cₑₓᵢₜ, also applies to the irreversible filter, but of course the details of the function Z will be different. The decision protocol in the Table above with cells 1-11 still holds but, cₑₓᵢₜ≤c_{gas} in all cases for an irreversible filter, so that the events in cells 4, 5, 9, and 10 will never occur. The other events are still possible and the relayed status messages, recommendations, and ON/OFF switching control remain valid.

The described reversible formaldehyde filter for example acts simultaneously as an irreversible absorption filter for acidic gases. Status messages concerning the degree of filter loading and the end-of-filter life with respect to acidic gases can thus still be given.

The invention is of interest for indoor air cleaners, ventilation or HVAC (heating, ventilation and air conditioning systems) and other air handling units. In the case of an HVAC system, the ventilation recommendations explained above may be implemented automatically.

As discussed above, embodiments make use of a controller. The controller can be implemented in numerous ways, with software and/or hardware, to perform the various functions required. A processor is one example of a controller which employs one or more microprocessors that may be programmed using software (e.g., microcode) to perform the required functions. A controller may however be implemented with or without employing a processor, and also may be implemented as a combination of dedicated hardware to perform some functions and a processor (e.g., one or more programmed microprocessors and associated circuitry) to perform other functions.

Examples of controller components that may be employed in various embodiments of the present disclosure include, but are not limited to, conventional microprocessors, application-specific integrated circuits (ASICs), and field-programmable gate arrays (FPGAs).

In various implementations, a processor or controller may be associated with one or more storage media such as volatile and non-volatile computer memory such as RAM, PROM, EPROM, and EEPROM. The storage media may be encoded with one or more programs that, when executed on one or more processors and/or controllers, perform at the required functions. Various storage media may be fixed within a processor or controller or may be transportable, such that the one or more programs stored thereon can be loaded into a processor or controller.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. A filtration system for removing a target gaseous pollutant from a gas to be filtered in an indoor space, the filtration system comprising:
a sensor arrangement, which comprises a gas sensor for sensing a concentration of a target gas in the indoor space;
an air cleaner which comprises a filter for filtering the target gas from the gas to be filtered, and a ventilation system for controllably driving air through the filter, wherein the filter comprises a reversible absorption filter or a reversible adsorption filter; and
a controller for controlling ventilation system air flow settings,
wherein the controller is adapted, based on current sensor arrangement signals, and a previous history of the sensor arrangement signals, and previous ventilation system air flow settings, to:
determine a degree of filter loading with the target gas;
determine from the degree of filter loading with the target gas a concentration of the target gas in the air flow exiting the air cleaner; and
determine when filter regeneration is taking place and when air filtering is taking place from the determined concentration of the target gas in the air flow exiting the air cleaner.

2. A filtration system as claimed in claim 1, wherein the controller is further adapted to determine when the filter has reached its end of life based on the degree of filter loading with the target gas.

3. A filtration system as claimed in claim 2, wherein the controller is further adapted to switch off the ventilation system when it is determined that the filter has reached its end of life.

4. A filtration system as claimed in claim 1, wherein the controller is further adapted to switch off the ventilation system to save energy when it is determined that the gas sensor reading is below a first threshold and the determined concentration of the target gas in the air flow exiting the air cleaner is below a second threshold.

5. A filtration system as claimed in claim 1, wherein the controller is further adapted to:
determine that filter regeneration is taking place when the determined concentration of the target gas in the air flow exiting the air cleaner is greater than the gas sensor reading; and
determine that air filtering is taking place when the determined concentration of the target gas in the air flow exiting the air cleaner is lower than the gas sensor reading.

6. A filtration system as claimed in claim 1, wherein the controller is further adapted to:
determine that the filter has reached its end of life when the determined concentration of the target gas in the air flow exiting the air cleaner is above a third threshold.

7. A filtration system as claimed in claim 1, wherein the controller is further adapted to:
provide an output which indicates when additional ventilation of the indoor space with outdoor air is desirable when outdoor concentration levels of the target gas is lower than indoor concentration levels of the target gas.

8. A filtration system as claimed in claim 1, wherein the gas sensor comprises a formaldehyde sensor, wherein the target gas is formaldehyde, wherein the filter comprises a reversible formaldehyde filter, and wherein the degree of filter loading Γ(t) with formaldehyde is determined at successive moments in time t=tᵢ (i=0, 1, 2, . . . , i−1) via the formula:
Γ(tᵢ)=Γ(tᵢ₋₁)+ϕ_{c}(t₁)×Δt×(c_{gas}(tᵢ)−Z(ϕ_{c}(tᵢ),RH(tᵢ),T(tᵢ),Γ(tᵢ₋₁),c_{gas}(tᵢ))
wherein the time interval Δt=tᵢ−tᵢ₋₁; wherein Γ represents the absorbed amount of formaldehyde gas; wherein ϕₖ represents the airflow rate at the pertaining ventilation system air flow setting;
wherein RH represents the relative humidity in the indoor space; wherein T represents the temperature in the indoor space; wherein c_{gas} represents the concentration of a target gas in the indoor space; and wherein Z(ϕ_{c}(tᵢ),RH(tᵢ),T(tᵢ),Γ(tₜ₋₁),c_{gas}(tᵢ) represents the formaldehyde concentration in the air exiting the filter.

9. A filtration system as claimed in claim 1, wherein the sensor arrangement further comprises:
a temperature sensor; and
a relative humidity sensor.

10. A method of controlling a filtration system for removing a target gaseous pollutant from a gas to be filtered in an indoor space, the method comprising:
sensing a concentration of a target gas in the indoor space; and
controlling air flow settings of a ventilation system of an air cleaner, the air cleaner comprising a filter for filtering the target gas from the gas to be filtered, and the ventilation system for controllably driving air through the filter, wherein the filter comprises a reversible absorption filter or a reversible adsorption filter,
wherein the controlling step comprises, based on current sensed values, and a previous history of the sensed values, and previous ventilation system air flow settings:
determining a degree of filter loading with the target gas;
determining from the degree of filter loading a concentration of the target gas in the air flow exiting the air cleaner; and
determining when filter regeneration is taking place and when air filtering is taking place from the determined concentration of the target gas in the air flow exiting the air cleaner.

11. A method as claimed in claim 10, wherein the controlling step further comprises determining when the filter has reached its end of life based on the degree of filter a loading with the target gas.

12. A method as claimed in claim 10, comprising switching off the ventilation system when it is determined that:
the filter has reached its end of life; or when it is determined that
the gas sensor reading is below a first threshold and the determined concentration of the target gas in the air flow exiting the air cleaner is below a second threshold.

13. A method as claimed in claim 10, comprising:
determining that filter regeneration is taking place when the determined concentration of the target gas in the air flow exiting the air cleaner is greater than the gas sensor reading; and
determining that air filtering is taking place when the determined concentration of the target gas in the air flow exiting the air cleaner is lower than the gas sensor reading.

14. A method as claimed in claim 10, comprising: determining that the filter has reached its end of life when the determined concentration of the target gas in the air flow exiting the air cleaner is above a third threshold.

15. A method as claimed in claim 10, further comprising providing an output which indicates when additional ventilation of the indoor space with outdoor air is desirable when outdoor concentration levels of the target gas is lower than indoor concentration levels of the target gas.
